(19) United States
(12) Patent Application Publication
(10) Pub. No.: US 2010/0283839 A1
(43) Pub. Date: Nov. 11, 2010

(54) STEREOSCOPIC DISPLAY APPARATUS AND METHOD AND STEREOSCOPIC DISPLAY WALL

(76) Inventors: Chunfeng Liu, Kunshan (CN); Chi-Tien Lee, Kunshan (CN)

Correspondence Address: Customer No. 70416;Perkins Coie LLP, Patent - LA, P.O. Box 1208, Seattle, WA, 98111-1208, US

(21) Appl. No.: 12/512,993

(22) Filed: Jul. 31, 2009

(30) Foreign Application Priority Data
May 7, 2009 (CN) 200910136326.6

(51) Int. Cl. H04N 13/04

(52) U.S. Cl. 348/51; 348/E13.001

(57) ABSTRACT

A stereoscopic display apparatus includes a display, a raster, a positioning unit, an information processing unit and a drive unit. The display displays a 2-dimensional image. The raster, situated in front of the display and having size-adjustable openings, opens and closes the openings and generates a left-eye view and a right-eye view from the 2-dimensional image. The positioning unit obtains and sends location information of a viewer. The information processing unit calculates, based on the location information of the viewer, sizes of the openings located in different areas of the raster and sizes of corresponding display areas on the display and sends a calculation result. The drive unit adjusts the sizes of the openings located in different areas of the raster and the sizes of corresponding display areas on the display according to the calculation result.

### FIELD OF THE INVENTION

The present invention relates to the field of stereoscopic displays, and particularly to a stereoscopic display apparatus and method and a stereoscopic display wall.

### BACKGROUND

3-dimensional (3D) stereoscopic display technology has been developing rapidly in recent years and has shown promising prospects for applications in virtual display, 3D games, 3D advertisements, aeronautics and astronautics, nuclear technologies, and biomolecule studies, etc.

Conventional stereoscopic display technology requires a viewer to wear a special tool, e.g., glasses or a helmet. However, wearing such a tool restricts the viewer from doing work irrelevant to the display, is inconvenient, and makes the viewer feel uncomfortable. What is more, after watching the conventional stereoscopic display for a long time, the viewer gets tired easily and can catch what is known as virtual reality sickness. Therefore, another stereoscopic display technology, i.e., naked-eye stereoscopic display technology, has become a focus of recent researches.

Naked-eye stereoscopic display technology does not require the viewer to wear any tool and is hence more flexible and practical. Such technology includes two types. One type includes: dividing a 2-dimensional (2D) image into a foreground image and a background image and adding a depth of field indication to generate a 3D image, which means correctly dividing an image is the most difficult task for generating a successful 3D image. The other type includes: providing different parts of the 2D image to the eyes of the viewer respectively by utilizing optical effects to create parallactic difference between the two eyes so that the viewer, with the physiological function of merging visual perceptions from the two eyes, has a stereoscopic impression on the 2D image. The stereoscopic display apparatus developed based on the parallactic difference of the two eyes is the focus of the current naked-eye stereoscopic display technology and a raster stereoscopic display apparatus is now mainstream.

However, the viewing area of the raster stereoscopic display apparatus is limited to some extent.

In addition, according to the raster stereoscopic display apparatus, the left eye as well as the right eye respectively may see images of different display areas at the same time, which causes 3D perception weariness to the viewer.

### SUMMARY

Embodiments of the present invention provide a stereoscopic display apparatus and method with a larger viewing area.

Embodiments of the present invention also provide a stereoscopic display wall, which provides 3D viewing from different angles and provides a 3D scene that changes as the location of a viewer changes.

According to an embodiment of the present invention, a stereoscopic display apparatus includes: a display, a raster, a positioning unit, an information processing unit and a drive unit; wherein

the display displays a 2-dimensional image;

the raster, located in front of the display and having at least two openings whose sizes are adjustable, opens and closes the at least two openings and generates a left-eye view and a right-eye view from the 2-dimensional image;

the positioning unit obtains location information of the viewer and input the location information to the information processing unit;

the information processing unit calculates, based on the location information of the viewer, sizes of the at least two openings located in different areas of the raster and sizes of display areas corresponding to the at least two openings on the display, and sends a calculation result to the drive unit; and

the drive unit adjusts the sizes of the at least two openings located in different areas of the raster and the sizes of the display areas on the display according to the calculation result.

According to another embodiment of the present invention, a stereoscopic display method includes:

displaying a 2-dimensional image by a display;

obtaining location information of a viewer;

calculating, based on the location information of the viewer, sizes of openings located in different areas of a raster and sizes of display areas corresponding to the openings on the display and obtaining a calculation result;

adjusting the sizes of the openings located in different areas of the raster and the sizes of display areas corresponding to the openings on the display according to the calculation result; and

generating a left-eye view and a right-eye view by opening and closing the openings, and obtaining a stereoscopic image by utilizing a physiological function of merging the left-eye view and the right-eye view.

According to another embodiment of the present invention, a stereoscopic display wall includes: at least two display apparatuses, at least one positioning apparatus and a control apparatus;

wherein each of the at least two display apparatuses includes a display and a raster situated in front of the display, the display displays a 2-dimensional image, and the raster having at least two openings whose sizes are adjustable generates a left-eye view and a right-eye view from the 2-dimensional image by opening and closing the openings;

wherein the at least one positioning apparatus obtains location information of a viewer and sends the location information to the control apparatus; wherein the control apparatus includes a location information processing unit, a user control unit, an image processing unit and an image distribution unit, wherein

the location information processing unit calculates, based on the location information of the viewer, sizes of the at least two openings located in different areas of the raster and sizes of display areas corresponding to the at least two openings on the display, and sends a calculation result to the image processing unit;

the user control unit parses operation information from a user and sends a user instruction to the image processing unit;

the image processing unit adjusts the sizes of the at least two openings located in different areas of the raster and the sizes of the display areas on the display according to the calculation result, and reconstructs and adjusts images according to the user instruction; and

the image distribution unit distributes the reconstructed or adjusted images to the at least two display apparatuses to be displayed

The stereoscopic display apparatus and method and the stereoscopic display wall according to embodiments of the present invention automatically open or close the openings of the raster and adjust the sizes of the openings in accordance with the viewing angle of the viewer. Accordingly, sight lines of the left eye and the right eye of the viewer, wherever the viewer is situated in front of the stereoscopic display apparatus and whichever viewing angle the viewer takes, are not limited by openings with the fixed sizes in the raster. Consequently, the viewer is able to observe the 3D image in a larger viewing area. The sizes of the openings are adjustable, which can avoid overlapping of the left-eye view and the right-eye view through adjusting the sizes of the openings and can thus avoid 3D perception weariness.

### BRIEF DESCRIPTION OF THE DRAWINGS

The above features and merits of the present invention are made more apparent with the accompanying drawings. In all the accompany drawings, the same reference sign indicates the same part of a system. The drawings are not necessarily to scale, but focus on illustrating the principles of the present invention.

FIG. 1 is a schematic diagram illustrating a raster stereoscopic display apparatus.

FIG. 2 is a schematic diagram illustrating a stereoscopic display apparatus in accordance with Embodiment 1.

FIG. 3 is a schematic diagram illustrating a relation among a location of a viewer, openings of a raster and display areas at a certain time in accordance with Embodiment 1.

FIG. 4 is a schematic diagram illustrating images for a left eye and a right eye respectively after opening and closing the openings of the raster for one time in accordance with Embodiment 1.

FIG. 5 is a top sectional view of the stereoscopic display apparatus in accordance with Embodiment 1.

FIG. 6 is a side sectional view of the stereoscopic display apparatus in accordance with Embodiment 1.

FIG. 7 is a schematic diagram illustrating a stereoscopic display wall in accordance with Embodiment 2.

FIG. 8 is a flowchart illustrating a stereoscopic display method in accordance with Embodiment 3.

### DETAILED DESCRIPTION OF EMBODIMENTS

To make the above features and merits of the present invention more apparent, embodiments of the present invention are hereinafter described in detail with reference to accompanying drawings.

Many details are given in the following description so that the present invention can be understood thoroughly. However, the present invention can be implemented in ways different from the description herein. Hence the present invention is not limited to the embodiments disclosed herein.

In addition, as the present invention is described in detail with reference to the accompanying drawings, a part of the sectional view illustrating a structure of an apparatus in the embodiments of the present invention may be enlarged out of proportion to give a clearer image of the part. Moreover, the accompanying drawings are only examples of the present invention and are not used to limit the protection scope of the present invention. Furthermore, in practical application, 3D sizes, i.e., length, width and depth, of the apparatus shall be taken into consideration.

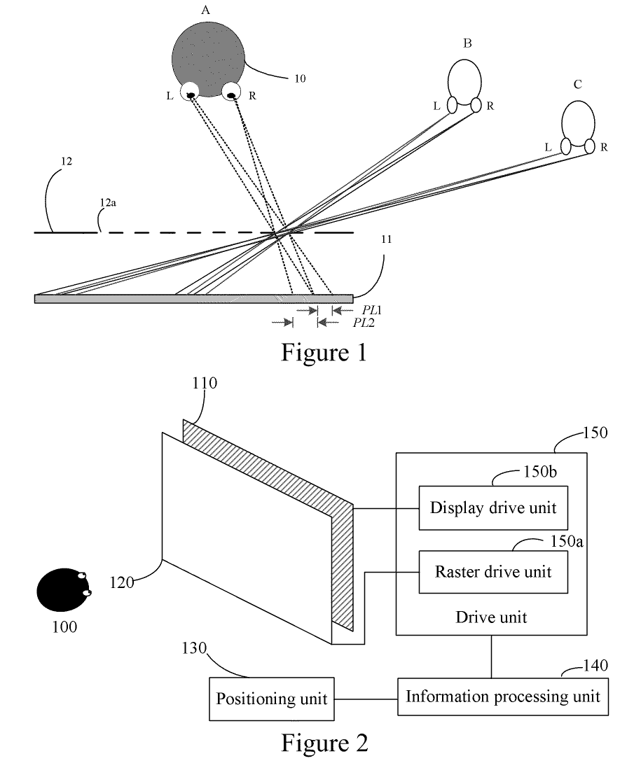

FIG. 1 is a schematic diagram illustrating a raster stereoscopic display apparatus, and as shown in FIG. 1, the raster stereoscopic display apparatus mainly includes a flat panel display 11 and a raster 12. The flat panel display 11 may be a liquid crystal display, a plasma display or an organic light emitting display. The raster 12 includes multiple openings 12a with fixed locations and sizes. During a displaying process, by controlling open and close statuses of the openings 12a in the raster 12, the left eye and the right eye of the viewer can see a left-eye view and a right-eye view respectively and the stereoscopic display effect is achieved by utilizing the physiological function of merging visual perceptions from the two eyes. For example, the viewer 10 in FIG. 1 is situated at location A, the left eye L of the viewer sees the area PL1 of the flat panel display 11 through an opening 12a and the right eye R of the viewer sees the area PL2 through the same opening 12a; the areas PL1 and PL2 complement each other but do not overlap. By controlling the open and close statuses of the opening 12a, the left eye and the right eye of the viewer respectively see the 2D image in the areas PL1 and PL2 and a stereoscopic image can be obtained by utilizing the brain's physiological function of merging visual perceptions from the two eyes. However, when the viewer 10 is situated at location C, an area seen by the right eye R of the viewer through the same opening 12a as in location A is at the edge of the flat panel display. If the viewer 10 continues to move clockwise, the viewer 10 is unable to see any display area. Consequently, location C is a boundary of a viewing area. As can be seen, the viewing area of the raster stereoscopic display apparatus is limited to some extent. In addition, when the viewer 10 is situated at location C or location B, areas seen by the left eye and the right eye of the viewer respectively on the flat panel display overlap, thereby making the left eye as well as the right eye see different areas at the same time and further causing stereoscopic image perception weariness to the viewer. As can be concluded from the above, an outstanding problem is that a viewer usually cannot get a desired stereoscopic image when the viewer changes the viewing angle, i.e., the viewing area of the 3D observation is relatively small for the viewer. Moreover, the left eye as well as the right eye respectively sees the images of different display areas at the same time, which causes 3D perception weariness to the viewer.

In view of the above, an embodiment of the present invention provides a stereoscopic display apparatus, which includes a raster with adjustable openings. The sizes of the openings may be adjusted in accordance with the viewing angle of the eyes of the viewer so that the 3D image can be observed in a larger viewing area.

The stereoscopic display apparatus in accordance with an embodiment of the present invention is described hereinafter with reference to the accompanying drawings.

### Embodiment 1

FIG. 2 is a schematic diagram illustrating a stereoscopic display apparatus in accordance with Embodiment 1.

As shown in FIG. 2, a viewer 100 is situated in front of the stereoscopic display apparatus and the stereoscopic display apparatus includes: a flat panel display 110, a raster 120, a positioning unit 130, an information processing unit 140 and a drive unit 150.

The flat panel display 110 displays a 2D image. The raster 120, located in front of the flat panel display 110 and including at least two size-adjustable openings (not shown in FIG. 2), generates a left-eye view and a right-eye view from the 2D image by opening and closing the openings. The positioning unit 130 obtains location information of the viewer 100 and input the location information to the information processing unit 140. The information processing unit 140 calculates, based on the location information of the viewer 100, sizes of the openings located in different areas of the raster 120 and the sizes of corresponding display areas on the flat panel display 110, and sends a calculation result to the drive unit 150. The drive unit 150 adjusts the sizes of the openings located in different areas of the raster 120 and the sizes of corresponding display areas on the flat panel display 110 according to the calculation result.

In this embodiment, the location information of the viewer 100 includes: distance between the viewer 100 and the flat panel display 110, and viewing angle between the viewer 100 and the flat panel display 110. The raster 120 may be a liquid crystal cell, i.e., a liquid crystal panel. The liquid crystal cell includes a plurality of pixel units in matrix (not shown in FIG. 2). The raster in the present invention is not limited to the liquid crystal cell but may be any raster with size-adjustable openings in other embodiments of the present invention.

Each opening of the raster 120 includes at least one pixel unit. The pixel units that are or aren't transmitted by light may be adjusted by controlling the number of pixel units which are turned on and the number of pixel units which are turned off, thereby adjusting and controlling the sizes of the openings at different locations. The openings of the raster in accordance with the present invention are not limited to physical openings and may be other photoelectric components. Essentially, the opening is an optical valve controlling passage of light.

The flat panel display 110 may include, but is not limited to, a liquid crystal display, a plasma display panel or an organic light emitting display, and shows the 2D image.

The drive unit 150 includes: a raster drive module 150a and a display drive module 150b. The raster drive module 150a adjusts the sizes of the openings located in different areas of the raster 120 according to the calculation result, and the display drive module 150b adjusts the sizes of the display areas corresponding to the openings on the flat panel display 110 according to the calculation result.

When the viewer 100 watches the stereoscopic display apparatus, the positioning unit 130 obtains data on the distance between the flat panel display 110 and the human eyes (including the left eye and the right eye) and on the viewing angle between the flat panel display 110 and the human eyes, and inputs the data to the information processing unit 140. The information processing unit 140 calculates, based on the data, the sizes of the opened and closed openings in the raster 120 and the sizes of corresponding display areas on the flat panel display 110 (the calculation will be explained in detail hereinafter with reference to FIG. 4), and inputs the calculation result to the raster drive module 150a and the display drive module 150b. The raster drive module 150a drives the raster 120 and therefore adjusts the sizes of the openings according to the calculation result, and the display drive module 150b drives the flat panel display 110 and therefore controls the images shown in the display areas corresponding to the openings. Because the sizes of the opened and closed openings of the raster are adjusted automatically in accordance with the viewing angle of the viewer, the sight lines of the left eye and the right eye of the viewer, wherever the viewer is situated in front of the stereoscopic display apparatus and whichever viewing angle the viewer takes, are not limited by openings with fixed sizes in the raster (such as the raster in FIG. 1). Therefore, the viewer is able to observe the 3D image in a larger viewing area.

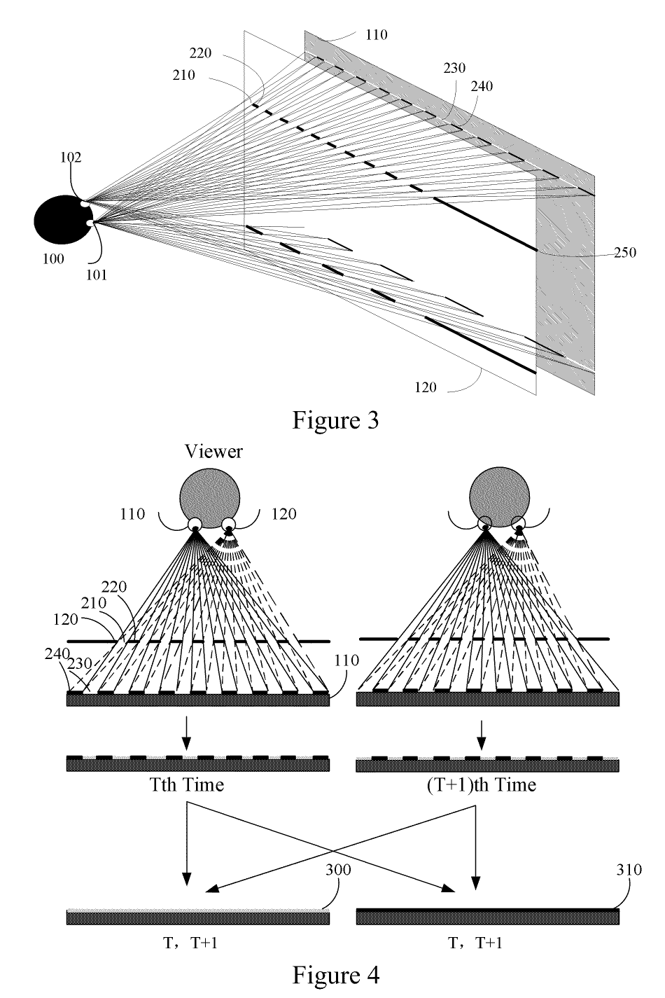

FIG. 3 is a schematic diagram illustrating a relation among a location of a viewer, openings of a raster and display areas at a certain time in accordance with Embodiment 1. As shown in FIG. 3, at a certain time, a light control unit 250 in a row in the raster 120 includes an open area 210 and a close area 220, and the sizes of the open area 210 and the close area 220 vary in different locations and are calculated based on the location of the viewer 100. The right eye 101 sees a display area 230 on the flat panel display 110 through the open area 210, the left eye 102 sees the display area 240 through the open area 210, and the display area 230 and the display area 240 complement each other without overlapping.

FIG. 4 is a schematic diagram illustrating images for a left eye and a right eye respectively after opening and closing the openings of the raster for one time in accordance with Embodiment 1. As shown in FIG. 4, at the Tth time, the open area 210 opens and the close area 220 closes, the right eye 101 sees the display area 230 through the open area 210, the left eye 102 sees the display area 240 through the open area 210, and the display area 230 and the display area 240 complement each other without overlapping. At the (T+1)th time, the open area 210 at the Tth time closes while the close area 220 at the Tth time opens, therefore the right eye 101 sees the display area 240 of the last time (i.e. he Tth time) through an open area (which is the close area at the Tth time) and the left eye 102 sees the display area 230 through the open area. In this way, the left eye and the right eye can combine images 300 and 301 appearing at the Tth time and the (T+1) the time which are adjacent to each other respectively after one round of opening and closing of the openings to obtain a complete 3D image. Along with continuous change of the viewing angle, by combining the images seen by the left eye and the right eye of the viewer, the 3D image provided on the flat panel display 110 can be shown completely and vividly to the viewer. Obviously, when all the openings of the raster open, the stereoscopic display apparatus will apparently in a 2D display mode, and hence the switch between the 2D display mode and a 3D display mode may be achieved by controlling the raster.

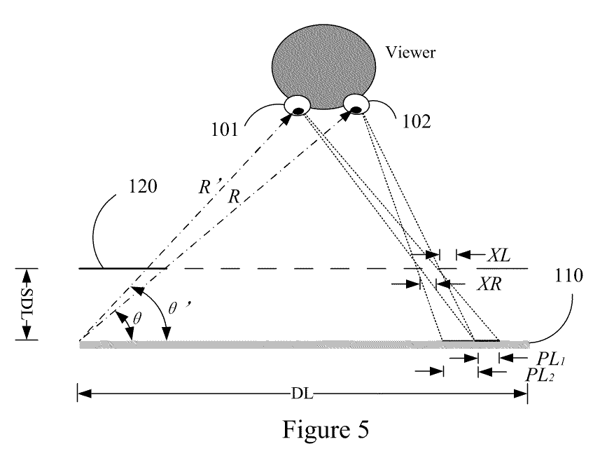

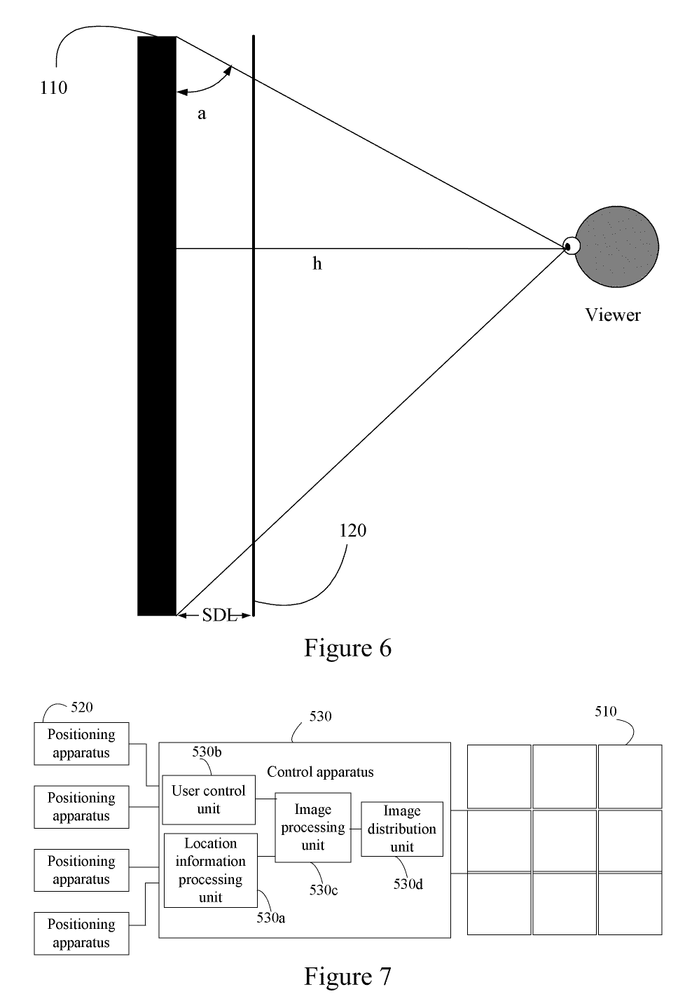

The formulas for calculating the sizes of the raster's openings and the sizes of the corresponding display areas are explained hereinafter with reference to FIGS. 5 and 6.

FIG. 5 is a top sectional view of the stereoscopic display apparatus in accordance with Embodiment 1 and FIG. 6 is a side sectional view of the stereoscopic display apparatus in accordance with Embodiment 1. To make certain features of the present invention more prominent, the positioning unit, the information processing unit and the drive unit are omitted in the figures. At the Tth time, the right eye 101 sees a display area PL1 through an open area XR, the left eye 102 sees a display area PL2 through the open area XR, and the display areas PL1 and PL2 complement each other without overlapping. According to the positioning unit, in the top sectional view in FIG. 5, the distances from the left eye 102 and the right eye 101 to the right edge of the flat panel display 110 are R and R′ respectively, the angles between the flat panel display 110 and the sight lines from the left eye 102 and the right eye 101 to the right edge of the flat panel display 110 are θ and θ′ respectively. In the side sectional view, the angle between the flat panel display 110 and a sight line from the eyes to the top edge of the flat panel display 110 is α. Further, it is supposed: the width of the flat panel display is DL, the width of every pixel is d and a vertical distance from the flat panel display 110 to the raster 120 is SDL. The formula can be expressed as follows:

$$DL = {\sum }_{i = 1}^{n} \{ {PL}_{1} ( i ) + {PL}_{2} ( i ) \}$$

where PL₁(i) stands for an area visible to the right eye on the display panel corresponding to an ith opening of the raster at a certain time, i=1, 2, 3, . . . n; and

PL₂(i) stands for an area visible to the left eye on the display panel corresponding to the ith opening of the raster at a certain time, i=1, 2, 3, . . . n.

Further, PL₁(i)=m₁(i)·d, where m₁(i) is the number of pixels contained in PL₁(i); PL₂(i)=m₂(i)·d, where m₂ (i) is the number of pixels contained in

$${PL}_{2} ( i ) ⇒ DL = d {\sum }_{i = 1}^{n} \{ {m}_{1} ( i ) + {m}_{2} ( i ) \}$$

According to the geometrical theory applied to the schematic diagrams, it can be deduced that:

$$\begin{matrix}{\sum }_{i = 1}^{n} XL ( i ) = \frac{DL}{sin α} \cdot \frac{{( R \cdot Sin θ - SDL )}^{2} \cdot {R}^{′} \cdot Sin {θ}^{′}}{R \cdot Sin θ \cdot \{ \begin{matrix}( {R}^{′} \cdot Sin {θ}^{′} - SDL ) \cdot R \cdot Sin θ + \\ ( R \cdot Sin θ - SDL ) \cdot {R}^{′} \cdot Sin {θ}^{′}\end{matrix} \}} & ( 1 ) \\ {\sum }_{i = 1}^{n} XR ( i ) = \frac{DL \cdot ( {R}^{′} \cdot Sin {θ}^{′} - SDL ) \cdot ( R \cdot Sin θ - SDL )}{sin α \cdot R \cdot Sin θ ( {R}^{′} \cdot Sin {θ}^{′} - SDL ) + {R}^{′} \cdot Sin {θ}^{′} ( R \cdot Sin θ - SDL )} & ( 2 ) \\ {\sum }_{i = 1}^{n} PL 1 ( i ) = \frac{DL \cdot {R}^{′} \cdot Sin {θ}^{′} ( R \cdot Sin θ - SDL )}{sin α \cdot ( {R}^{′} \cdot Sin {θ}^{′} - SDL ) \cdot R \cdot Sin θ + ( R \cdot Sin θ - SDL ) \cdot {R}^{′} \cdot Sin {θ}^{′}} & ( 3 ) \\ {\sum }_{i = 1}^{n} PL 2 ( i ) = \frac{DL \cdot ( {R}^{′} \cdot Sin {θ}^{′} - SDL ) \cdot R \cdot Sin θ}{sin α \cdot R \cdot Sin θ ( {R}^{′} \cdot Sin {θ}^{′} - SDL ) + {R}^{′} \cdot Sin {θ}^{′} ( R \cdot Sin θ - SDL )} & ( 4 )\end{matrix}$$

Where XL(i) stands for the size of the opening of the raster corresponding to the area PL₁(i) visible to the right eye at a certain time; and

XR(i) stands for the size of the opening of the raster corresponding to the area PL₂(i) visible to the left eye at a certain time.

As can be seen, in the case that the specifications (including the width and the height) of the flat panel display and the distance between the raster and the flat panel display are determined, according to the location information of the viewer obtained by the positioning unit, the information processing unit can obtain the sizes of the openings located in different areas of the raster and the sizes of corresponding display areas according to the formulas (1)-(4). Therefore, 3D images which can be observed in a larger viewing area are generated by using the raster with size-adjustable openings. In addition, because the sizes of the openings are adjustable, it is possible to avoid the left-eye view and the right-eye view from overlapping through adjusting the sizes of the openings and thus to avoid 3D perception weariness of the viewer.

An important application of the stereoscopic display apparatus in accordance with the foregoing embodiments of the present invention is stereoscopic display wall technology (mainly used in the fields of large-scale display, medical display, etc.), which attracts more and more industry attention.

A stereoscopic display wall in accordance with an embodiment of the present invention is described in detail hereinafter with reference to accompanying drawings.

### Embodiment 2

FIG. 7 is a schematic diagram illustrating a stereoscopic display wall in accordance with Embodiment 2. As shown in FIG. 7, the stereoscopic display wall includes: multiple display apparatuses 510, at least one positioning apparatus 520 and a control apparatus 530.

Each of the multiple display apparatuses 510 includes a display and a raster situated in front of the display (similar to Embodiment 1 and not shown in the FIG. 7). The display displays a 2D image. The raster has at least two size-adjustable openings and generates a left-eye view and a right-eye view from the 2D image by opening and closing the openings.

The positioning apparatus 520 obtains location information of a viewer and inputs the location information to the control apparatus 530. The control apparatus 530 includes a location information processing unit 530a, a user control unit 530b, an image processing unit 530c and an image distribution unit 530d.

The location information processing unit 530a calculates, based on the location information of the viewer, the sizes of the openings located in different areas of the raster and the sizes of corresponding display areas on the display, and send a calculation result to the image processing unit 530c.

The user control unit 530b parses operation information from a user and sends a user instruction to the image processing unit 530c.

The image processing unit 530c adjusts the sizes of the openings located in different areas of the raster and the sizes of corresponding display areas on the display according to the calculation result, and reconstructs and adjusts images according to the user instruction.

The image distribution unit 530d distributes the reconstructed or adjusted images to the multiple display apparatuses 510 to be displayed.

The stereoscopic display wall formed by the multiple display apparatuses 510 may be in a flat form or non-flat form.

Based on the above, the stereoscopic display wall can achieve the following. When the viewer is watching the stereoscopic display wall from a specific location at the same time, each of the display apparatuses 510 can display every view of a whole 3D scene, e.g. a front view, a rear view, a left side view, a right side view, a top view, a bottom view, a left-bottom view, a right-top view, etc. In other words, the viewer can enjoy the 3D observation from different viewing angles without moving his body or taking any other action. When the whole stereoscopic display wall functions as a large 3D display apparatus, the stereoscopic display wall can also provide a 3D scene changing with the location of the viewer.

A stereoscopic display method in accordance with an embodiment of the present invention is described hereinafter with reference to the accompanying drawings.

### Embodiment 3

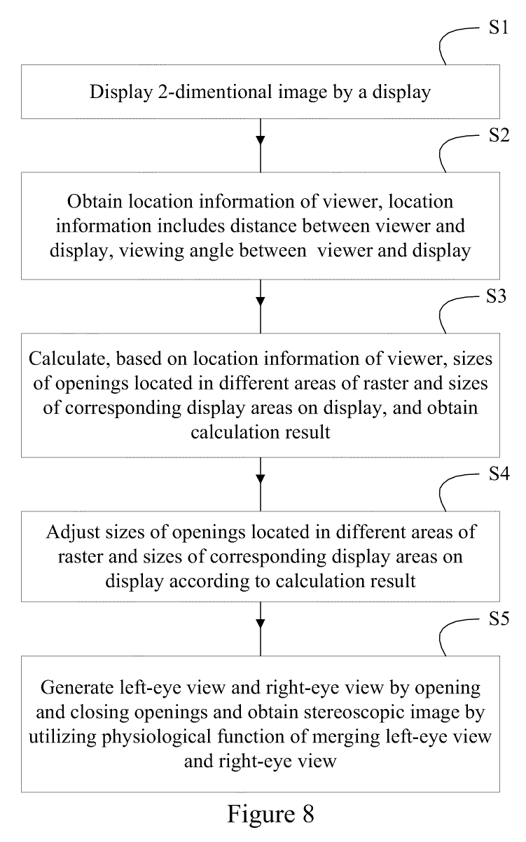

FIG. 8 is a flowchart illustrating a stereoscopic display method in accordance with Embodiment 3. As shown in FIG. 8, the stereoscopic display method is described below.

In Block S1, a 2D image is displayed with a display.

In Block S2, location information of a viewer is obtained, which includes distance between the viewer and the display and viewing angle between the viewer and the display.

In Block S3, sizes of openings located in different areas of a raster and sizes of corresponding display areas on the display are calculated based on the location information of the viewer, and a calculation result is thus obtained.

In Block S4, the sizes of the openings located in different areas of the raster and the sizes of corresponding display areas on the display are adjusted according to the calculation result.

In Block S5, a left-eye view and a right-eye view are generated from the 2D image by opening and closing the openings of the raster and a stereoscopic image is obtained by utilizing the physiological function of merging the left-eye view and the right-eye view.

Specifically, Block S4 may include: adjusting the sizes of the openings located in different areas of the raster according to the calculation result, and adjusting the sizes of the display areas which are located on the display and correspond to the openings according to the calculation result.

Although the foregoing embodiments take a flat-panel raster stereoscopic display apparatus as an example, i.e., both the raster and the display are in a flat-panel shape, the present invention is not limited to such raster and display and can also be applied to a non-flat raster stereoscopic display apparatus which includes a non-flat display equipped with a non-flat raster. The non-flat shape may include a curved shape, a folding shape, etc. In other words, the display may include, but is not limited to, a flat panel display, a curved display or a folding display, and the shape of the raster is the same as the shape of a display screen of the display. The non-flat raster stereoscopic display apparatus can also achieve the stereoscopic display effects achieved by the flat-panel raster stereoscopic display apparatus, i.e., the stereoscopic scene would not be distorted because the display screen is in the curved or folding shape but may be displayed even better on the contrary when the stereoscopic scene is larger and more complicated, thus enriching types of the raster stereoscopic display apparatus.

The foregoing descriptions are only embodiments of the present invention and are not for use in limiting the protection scope thereof in any way.

The embodiments of the present invention are disclosed herein and are not for use in limiting the present invention. Any one of ordinary skill in the art can make possible substitutions, modifications or equivalent replacement of the present invention based on the method and technical scheme disclosed herein without departing from the scope of the technical scheme of the present invention. Therefore, all simple substitutions, modifications or equivalent replacement of the present invention made based on the technical substance of the present invention without departing from the technical scheme of the present invention shall still be covered by the protection scope of the present invention.

What is claimed is:

1. A stereoscopic display apparatus, comprising: a display, a raster, a positioning unit, an information processing unit and a drive unit; wherein
the display displays a 2-dimensional image;
the raster, located in front of the display and having at least two openings whose sizes are adjustable, opens and closes the at least two openings and generates a left-eye view and a right-eye view from the 2-dimensional image;
the positioning unit obtains location information of the viewer and inputs the location information to the information processing unit;
the information processing unit calculates, based on the location information of the viewer, sizes of the at least two openings located in different areas of the raster and sizes of display areas corresponding to the at least two openings on the display, and sends a calculation result to the drive unit; and
the drive unit adjusts the sizes of the at least two openings located in different areas of the raster and the sizes of the display areas on the display according to the calculation result.

2. The stereoscopic display apparatus of claim 1, wherein the raster has a same shape as that of a display screen of the display.

3. The stereoscopic display apparatus of claim 1, wherein the raster is a liquid crystal cell comprising a plurality of pixel units in matrix.

4. The stereoscopic display apparatus of claim 3, wherein each of the at least two openings of the raster comprises at least one pixel unit.

5. The stereoscopic display apparatus of claim 1, wherein the display comprises a flat panel display, a curved display or a folding display.

6. The stereoscopic display apparatus of claim 1, wherein the display comprises a liquid crystal display, a plasma display or an organic light emitting display.

7. The stereoscopic display apparatus of claim 1, wherein the drive unit comprises: a raster drive module and a display drive module;
wherein the raster drive module adjusts the sizes of the at least two openings located in different areas of the raster according to the calculation result; and
the display drive module adjusts the sizes of the display areas corresponding to the at least two openings on the display according to the calculation result.

8. The stereoscopic display apparatus of claim 1, wherein the location information of the viewer comprises distance between the viewer and the display and a viewing angle between the viewer and the display.

9. A stereoscopic display method, comprising:
displaying a 2-dimensional image by a display;
obtaining location information of a viewer;
calculating, based on the location information of the viewer, sizes of openings located in different areas of a raster and sizes of display areas corresponding to the openings on the display and obtaining a calculation result;
adjusting the sizes of the openings located in different areas of the raster and the sizes of the display areas corresponding to the openings on the display according to the calculation result; and
generating a left-eye view and a right-eye view by opening and closing the openings, and obtaining a stereoscopic image by utilizing a physiological function of merging the left-eye view and the right-eye view.

10. The stereoscopic display method of claim 9, wherein the adjusting the sizes of the openings located in different areas of the raster and the sizes of the display areas corresponding to the openings on the display according to the calculation result comprises:
adjusting the sizes of the openings located in different areas of the raster according to the calculation result, and adjusting the sizes of the display areas which are located on the display and correspond to the openings according to the calculation result.

11. The stereoscopic display method of claim 9, wherein the raster is a liquid crystal cell comprising a plurality of pixel units in matrix, each of the openings of the raster comprises at least one pixel unit; and
wherein the adjusting the sizes of the openings located in different areas of the raster according to the calculation result comprises:
controlling the pixel units in the openings located in different areas of the raster to be or not to be transmitted by light according to the calculation result.

12. The stereoscopic display method of claim 9, wherein the obtaining the location information of the viewer comprises: obtaining distance between the viewer and the display and a viewing angle between the viewer and the display.

13. A stereoscopic display wall, comprising: at least two display apparatuses, at least one positioning apparatus and a control apparatus;
wherein each of the at least two display apparatuses comprises a display and a raster situated in front of the display, the display displays a 2-dimensional image, and the raster having at least two openings whose size are adjustable generates a left-eye view and a right-eye view from the 2-dimensional image by opening and closing the openings;
wherein the at least one positioning apparatus obtains location information of a viewer and sends the location information to the control apparatus;
wherein the control apparatus comprises a location information processing unit, a user control unit, an image processing unit and an image distribution unit, wherein
the location information processing unit calculates, based on the location information of the viewer, sizes of the at least two openings located in different areas of the raster and sizes of display areas corresponding to the at least two openings on the display, and sends a calculation result to the image processing unit;
the user control unit parses operation information from a user and sends a user instruction to the image processing unit;
the image processing unit adjusts the sizes of the at least two openings located in different areas of the raster and the sizes of the display areas on the display according to the calculation result, and reconstructs and adjusts images according to the user instruction; and
the image distribution unit distributes the reconstructed or adjusted images to the at least two display apparatuses to be displayed.

14. The stereoscopic display wall of claim 13, wherein each of the at least two display apparatuses is equipped with one positioning apparatus or the at least two display apparatuses are equipped with one positioning apparatus.

15. The stereoscopic display wall of claim 13, wherein the stereoscopic display wall is in a flat-panel shape or a non-flat shape.
